(19) United States
(12) Patent Application Publication
(10) Pub. No.: US 2006/0236011 A1
(43) Pub. Date: Oct. 19, 2006

(54) Ring management

(76) Inventors: Charles Narad, Los Altos, CA (US); Mark Rosenbluth, Uxbridge, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/021,178

(22) Filed: Apr. 15, 2005

(51) Int. Cl. G06F 13/14

(52) U.S. Cl. 710/240

(57) ABSTRACT

The disclosure describes techniques used by one or more producers and consumers of one or more rings.

### BACKGROUND

Rings (or “circular buffers”) are used to pass messages between agents such as central processing units (“CPUs”), I/O devices and co-processors. The messages may include data, pointers, and any other type of information to be exchanged between such agents. Rings are also used to pass messages between threads or processes running on a single agent. A ring is typically implemented by an array in memory, and a pair of pointers or offsets into that array which increment linearly through the entries in the array and “wrap”, modulo the ring size, when the end of the array is reached. One of these pointers is used to add a new entry onto the tail of the ring. This pointer is referred to as a “produce pointer”. The agent that performs the produce access (or enqueuing) operation using the produce pointer is referred to as the “producer”. The other pointer, referred to as a “consume pointer”, is used to remove entries from the head of the ring. The agent that performs the consume access (or dequeuing) operation is referred to as the “consumer”.

A particular pointer may be owned by a single agent. That agent would maintain a copy of the pointer that is used to determine which entry to read or write in the array. Alternatively, if a pointer is used by multiple producers and/or multiple consumers, each of the agents would require a mutual exclusion mechanism to enable that agent to atomically act on the ring pointers and associated entries.

The produce pointer is both read and written by the producer, which uses it and increments its value. Similarly, the consume pointer is both read and written by the consumer. A variety of mechanisms can be used to enable the consumer to determine if there is space available in the ring and to enable the producer to determine if there are any entries available in the ring. A common mechanism is to compare the consume and produce pointers, with an extra high-order bit in the pointers used to disambiguate a full ring from an empty one when the pointer values are otherwise equal. In this case, the produce pointer is also read by the consumer, and the consume pointer is read by the producer.

An agent sometimes maintains a private local copy of the pointer it owns in order to minimize overhead related to ring accesses. Also, for various reasons, agents may use “batch” notifications of enqueuing to or dequeueing from a ring so as to amortize the overheads for the agents. Thus, a producer might maintain a private copy of the produce pointer for use in writing entries into the ring, as well as a separate public copy of that pointer, updated less frequently, to pass “chunks” of entries to the consumer at one time. A consumer might similarly use a private and public copy of the consume pointer to indicate space being freed up, enabling “lazy” retirement and resource recovery to optimize those functions and to decouple them from servicing the ring. Thus, a private copy and public copy of a pointer serve the different functions of access and notification, respectively.

Having the producer read the consume pointer and the consumer read the produce pointer to determine ring status contributes to communications overhead. To minimize this overhead, ring credits are sometimes used. A ring credit indicates that there is a free ring entry for the producer to use. The consumer passes credits to the producer, which the producer adds to its local credit pool. The mechanism for passing credits involves delivery into a credit pool by the consumer and fetching from a credit pool by the producer. Credit passing can also be batched, which reduces the traffic used for producer credit notification but does not address the cost of notifying the consumer that the ring is non-empty.

### DESCRIPTION OF DRAWINGS

FIG. 1 is a block diagram of an exemplary multi-processor system that employs rings in a shared memory.

FIG. 2 is a diagram depicting exemplary ring data structures, including rings and associated ring descriptors, stored in the shared memory.

FIG. 3 is a diagram depicting message passing between agents using the ring data structures.

FIG. 4 shows an exemplary layout of a head descriptor.

FIG. 5 shows an exemplary layout of a tail descriptor.

FIG. 6 shows an exemplary layout of a public descriptor.

FIG. 7 shows an exemplary layout of a credit descriptor.

FIG. 8 shows an exemplary use of a public credits count maintained in the credit descriptor of FIG. 7.

FIG. 9 is a flow diagram illustrating an exemplary ring descriptor read operation.

FIG. 10 is a flow diagram of an exemplary “produce access” operation to store an item on a ring.

FIG. 11 is a flow diagram of an exemplary shared memory write operation used by the produce access operation of FIG. 10.

FIG. 12 is a state diagram for an exemplary timeout mechanism.

FIG. 13 is a flow diagram of an exemplary “consume access” operation to remove an item from a ring.

FIG. 14 is a flow diagram of an exemplary shared memory read operation used by the consume access operation of FIG. 13.

FIG. 15 is a flow diagram of an exemplary ring initialization process.

FIG. 16 is a block diagram of an exemplary networking application in which the system of FIG. 1 is employed.

### DETAILED DESCRIPTION

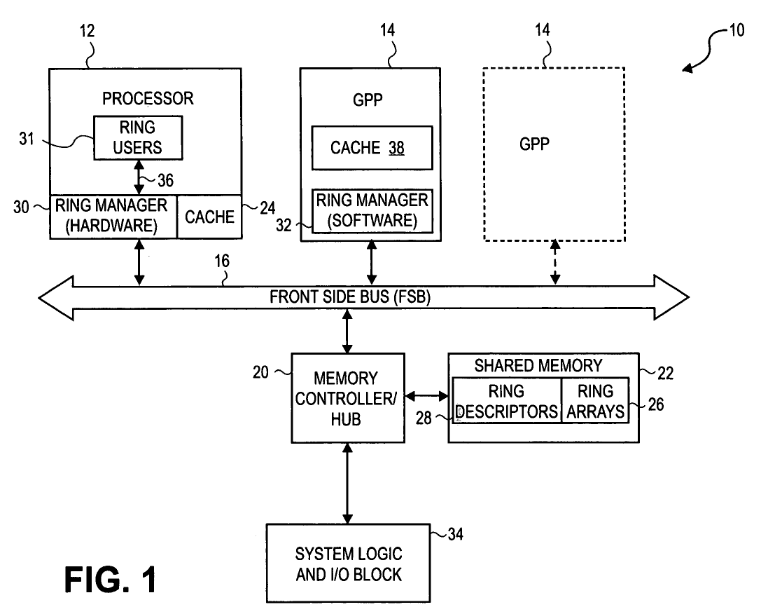

FIG. 1 shows a multi-processor system 10 in which a processor 12 and a general purpose processor (“GPP”) 14 are coupled to a system bus (referred to herein as a front side bus, “FSB”) 16. More than one GPP 14 may be connected to the FSB 16, as shown. More than one processor 12 may be connected to the FSB 16 as well. The GPP 14 may be a processor that has a CPU core and integrated cache, e.g., an Intel® Architecture processor (“IA processor”) such as the Intel® Xeon™ processor, or some other general purpose CPU. The processor 12 may be a specialized processor such as a network processor, e.g., one based on the Intel® Internet Exchange Architecture (IXA), that includes multiple multi-threaded Reduced Instruction Set Computer (RISC) cores (“microengines” (MEs)) and a general-purpose processor core integrated on the same die. Other types of processor architectures could be used. The GPP 14 and the processing elements of the processor 12 can initiate transactions on the FSB 16, and thus may be referred to collectively as bus agents, or more simply, agents.

Also coupled to the FSB 16 is a memory controller 20, which connects to a memory 22. The memory 22 is shared by and common to the various agents of the system 10. The memory controller 20 manages accesses to the shared memory 22 by such agents. The memory controller 20 may serve as a hub or bridge, and therefore includes circuitry that connects to and communicates with other system logic and I/O components, shown collectively as system logic and I/O block 34. Components in the system logic and I/O block 34 may connect to a backplane, external devices, and/or communication links.

The processor 12 and the GPP 14 each include a cache 24, 38. The size and organization of the cache are matters of design choice. For example, the cache 24 may be organized as an 8-way set associative cache, with each set including 2048 cache lines of 64 bytes per cache line. The cache may also comprise a hierarchy of caches of different sizes and organization.

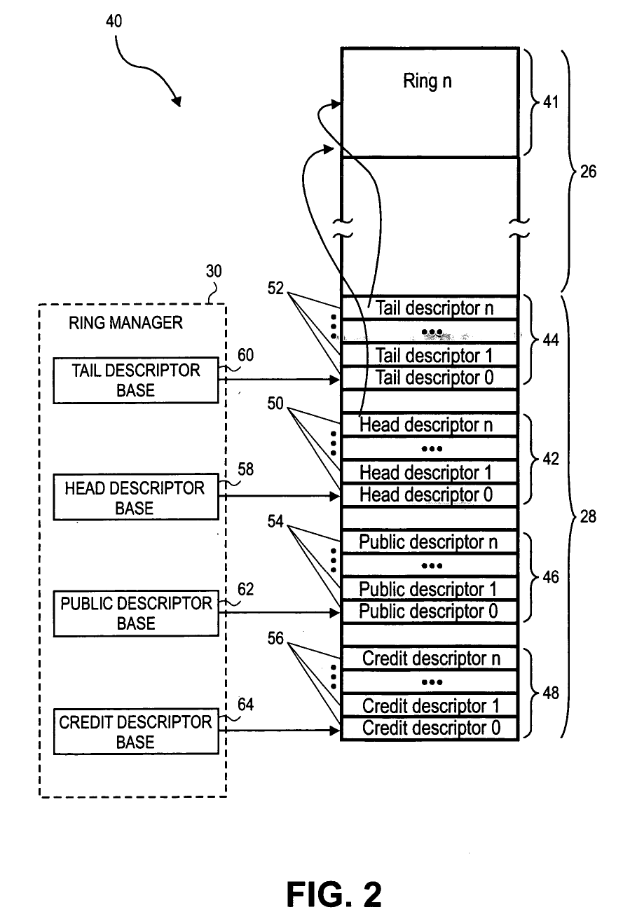

Maintained in the shared memory 22 are data structures implementing rings (e.g., ring arrays) 26 and associated ring descriptors 28. One side of each ring is managed by hardware, shown as ring manager 30, in the processor 12. The ring manager 30 is connected to and accessed by the processor's agents (e.g., MEs and control processor), shown as ring users 31, via internal bus 36. The ring manager 30 contains FIFOs (not shown) for buffering commands and data being transferred between the agents of the processor 12 and the shared memory 22. The set of command FIFOs include an array of enqueue FIFOs and an array of dequeue FIFOs presented to the agents as an array of registers (one enqueue register and one dequeue register per ring) used to place data on a ring or to remove data from a ring, respectively. The ring users 31 issue writes to entries in the array of enqueue registers or reads to entries in the array of dequeue registers, with other operations handled in the hardware of the ring manager itself. The ring manager 30 also includes Control and Status Registers (CSRs) to store ring configuration parameters (such as ring size) and base values for the ring descriptors, as will be discussed with reference to FIG. 2. The other side of each ring is managed and accessed by software executing on the GPP 14, shown as ring manager 32. The ring manager 32 may be implemented as part of the driver software, in one embodiment.

The ring manager 30 performs consume access (dequeue) and produce access (enqueue) operations when it receives commands on the internal bus 36. These ring access commands are received in the command FIFO registers, as discussed above. They may be in the form of “put” or “get” commands (e.g., for an ME ring user), or Load or Store instructions (e.g., for an Xscale core ring user), to give a few examples. The GPP 14 uses software routines of the ring manager 32 to perform consume and produce operations.

The ring manager 30 performs other operations besides ring management. For example, the ring manager 30 manages the FSB protocol and interrupts over the FSB 16, directs data to and from the cache 24, maintains a cache coherency protocol and manages cache activities (such as replacement, tag lookups and so forth) for the cache 24 in the processor 12.

The ring manager 30 provides the capability to move data to and from the shared memory 22. The types of access include: read accesses, write accesses and atomic read-modify-write accesses. Read and write accesses can specify whether or not to allocate space in the cache in the event of a cache miss. Atomic read-modify-write commands are used to maintain coherency over semaphores in the shared memory 22.

The processor 12 and GPP 14 allow selected areas of shared memory to be cached and a type of caching (called “memory type”) to be specified for selected areas. Supported memory types include: Uncacheable (UC); Write-Through (WT); Write Back (WB); Write Protected (WP); and Write Combining (WC).

If the UC memory type is specified, the selected area is not cached. For WT, writes and reads to and from selected area are cached. Reads come from cache lines on cache hits and read misses cause cache fills. All writes are written to a cache line and through to the shared memory. This mechanism enforces coherency between the various caches and the shared memory. With the WB memory type, writes and reads to and from shared memory are cached. Reads come from cache lines on cache hits; read misses cause cache fills. Write misses cause cache line fills, and writes are performed entirely in the cache, when possible. A write back operation is triggered when cache lines need to be deallocated. In WP mode, reads come from cache lines when possible, and read misses cause cache fills. Writes are propagated to the system bus and cause corresponding cache lines on all processors on the bus to be invalidated. When WC is used, shared memory locations are not cached, and writes may be delayed and combined in a write buffer to reduce memory accesses. The processor 12 and GPP 14 uses their respective caches to hold local copies of recently accessed data, including ring data and descriptors, from the shared memory, to reduce FSB 16 bandwidth used by the processors. Coherence (or consistency) may be maintained among multiple caches 24, 38 and shared memory 22 by a variety of different well known mechanisms such as snooping caches and directories and well-known protocols such as Modified Exclusive Shared Invalid (MESI) or Modified Owner Exclusive Shared Invalid (MOESI).

In one exemplary embodiment, as described herein, the snooping cache coherency protocol that is used is the MESI protocol, where “MESI” refers to the four cache states “modified” (M), “exclusive” (E), “shared” (S), and “invalid” (I). Each cache line in the cache can be in one of the four states. The ring data structures 26, 28 are used by the agents in such a way as to minimize the memory communication and resulting coherence traffic between the producing and consuming agent(s) on each ring, as will be described.

The GPP 14 uses both page cachability attributes and Memory Type Range Registers (MTRRs) to determine cache attributes of FSB accesses. Similarly, the processor 12 uses both FSB instruction type and MTRR to define FSB transaction cachability. The MTRRs allow the type of caching to be specified in the shared memory for selected physical address ranges. Table 1 below defines a cache allocation policy, according to the described embodiment. Other cache allocation policies may be used as well.

TABLE 1

| | | | Allocate Cache |
|---|---|---|---|
| | Selected Memory | Allocate Cache Line | Line on Write |
| No Allocate | Type | on Read Miss? | Miss? |
| No | WB, WT | Yes | Yes |
| No | WC, WP | Yes | No |
| No | UC | No | No |
| Yes | Any | No | No |

The ring manager 30 monitors (“snoops”) FSB 16 accesses from other processors, such as the GPP 14, and responds as required to keep the cache 24 and other processor's caches coherent. This snooping activity is handled by hardware in the ring manager 30, and is transparent to software. The snoop response can indicate a hit for addresses that are not actually in the cache but for which the cache has responsibility, since the ring manager 30 maintains coherency for data from the point in time that it has initiated a FSB read for data it intends to modify, until the data is written out on FSB 16. The modified data could be in flight from memory, in internal ring manager buffers, in the cache 24, in the process of being evicted from the cache 24, and so forth. The ring manager 30 will stall snoop responses when the address hits a locked cache line. Cache lines are locked during updates for ring operations, as will be described later.

As shown in FIG. 2, ring data structures 40 include the ring descriptors 28 and ring arrays 26 both of which are stored in the shared memory 22, as shown in FIG. 1. The ring arrays 26 include ring data storage regions 41 for each ring (for simplicity, only one—the ring data storage for ring ‘n’ 41—is shown). The ring data storage for the different rings need not be contiguous. Each ring is described by a unique ring descriptor. The ring descriptor is split into four descriptors each of which resides in an array of like descriptors indexed by the ring number: a head descriptor; a tail descriptor; a public descriptor; and a credit descriptor. Thus, there is an array of head descriptors 42, an array of tail descriptors 44, an array of public descriptors 46 and an array of credit descriptors 48. The array of head descriptors 42 includes a head descriptor 50 for each ring, that is, a head descriptor 0 for ring 0, a head descriptor 1 for ring 1, . . . , a head descriptor ‘n’ for ring ‘n’. Likewise there is a tail descriptor 52, a public descriptor 54 and a credit descriptor 56 for each ring. Each ring's descriptor is located by using that ring's number, relative to a base address stored in a respective CSR in the ring manager 30, as an index into the block of descriptors. More specifically, a head descriptor array base CSR 58, a tail descriptor array base CSR 60, a public descriptor array base CSR 62, and a credit descriptor array base CSR 64 hold base addresses for the head descriptor array 42, the tail descriptor array 44, the public descriptor array 46 and the credit descriptor array 48, respectively. A particular ring number will thus be used to access a head descriptor 52, a tail descriptor 50, a public descriptor 54 and a credit descriptor 56 one within each of those four arrays and each related to that particular ring. The head descriptor provides a pointer to the next entry or location to be read from the corresponding ring, while the tail descriptor provides a pointer the next entry or location to be written in the corresponding ring, as indicated in FIG. 2 for ring ‘n’. The different parts of the ring descriptor are separate so that they can be individually accessed and held in different cache lines (by different processors), which minimizes cache activity and coherence traffic due to false sharing. False sharing occurs when two agents with caches sharing a coherent memory system each are repeatedly accessing different and unrelated locations which happen to reside in the same cache line and thus causing extra and unnecessary coherence traffic between the caches of those two agents.

Each ring can be independently configured for size and can be independently located in memory (i.e., the different rings may not reside in a contiguous region of memory). Several techniques are applicable to ring size configuration. For example, a ring or group of rings could be configured by a control register indicating the ring size. Alternately, the ring size may be stored as data in a ring's descriptor. The size and the alignment of each memory array representing a ring may be restricted to a power of 2 to allow the full pointer to be stored in one location in the ring descriptor. By using the ring-size to determine which high-order bits to hold constant and which to include in the incrementing pointer, a ring base and an incrementing index for each ring can be stored efficiently in the ring's descriptor. Alternatively, one could support arbitrary alignment and/or arbitrary size of independently located rings by storing the ring upper_bound address and the ring size (or equivalently the ring_base and the ring size) and when the boundary is reached, the pointer is reset to the bound minus the size (or equivalently is set to the base value). Threshold values (e.g., for pushing out a new public pointer, for drawing credits from the public pool and for spilling credits to the public pool) are all configurable uniquely per ring.

The rings facilitate message passing between agents, in both directions. The hardware ring manager 30 may be defined with modes for communication in both directions, selected on a per-ring basis. That is, each ring is configurable to select whether the GPP(s) 14 or the hardware of the processor 12 acts as the consumer, and the other as the producer. The direction could be hardwired as well. A given ring is configured for use in one direction only.

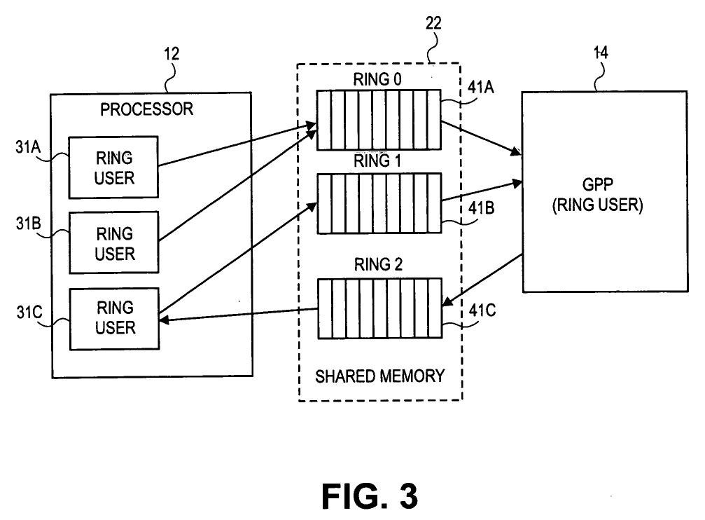

FIG. 3 shows the per-ring selected direction of message passing between the GPP 14 (as a ring user) and the ring users 31 of the processor 12 according to one example configuration. Shown in the figure are three ring users 31a, 31b and 31c, and three rings 41a, 41b and 41c. In this example, ring users 31a and 31b write to ring 41a (which is read by the GPP 14), ring user 31c writes to ring 41b (which is also read by GPP 14) and the GPP 14 writes to ring 41c (which in turn is read by ring user 31c). Thus, ring users 31a and 31b are producers and the GPP 14 is a consumer with respect to ring 41a, ring user 31 is a producer and the GPP 14a consumer with respect to ring 41b, and the GPP 14 is a producer and ring 31c is a consumer with respect to ring 41c. It may be noted that the content of the messages enqueued to and dequeued from a ring is completely up to application definition and is not observed or modified by the hardware of the ring manager 30.

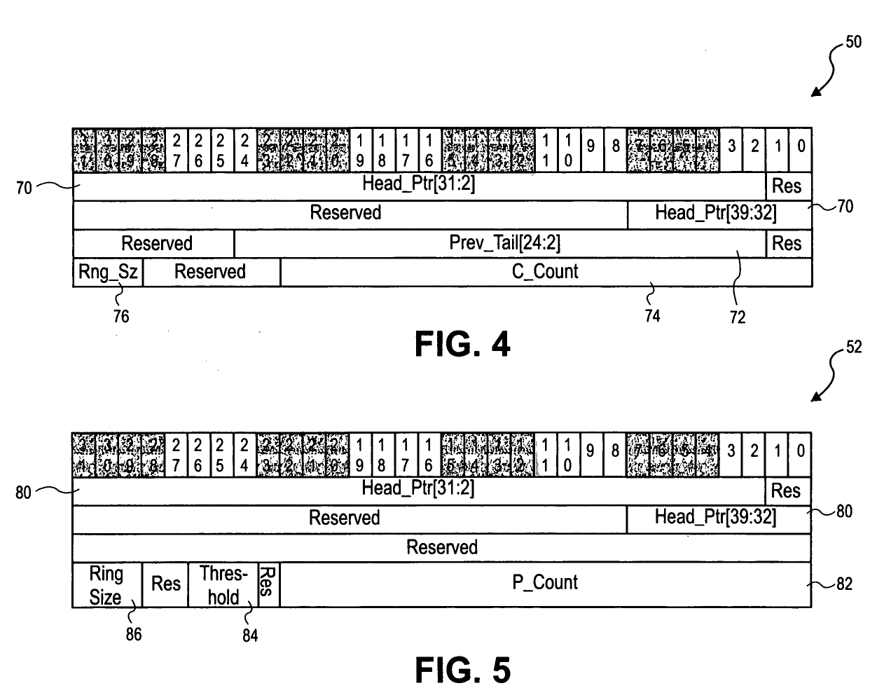

FIG. 4 shows an exemplary data structure layout for the head descriptor 50, which is accessed by only the consumer(s) on the associated ring. The head descriptor 50 holds the following fields: a head pointer (Head_Ptr) field 70, a previous tail pointer (Prev_Tail) field 72, and a derived ring count (C_Count) field 74. It can also store a copy of the ring size in a ring size field (Ring_Sz) 76.

FIG. 5 shows an exemplary data structure layout for the tail descriptor 52. The tail descriptor 52 is used by the producer(s) on the associated ring, and is never accessed by a consumer. The tail descriptor 52 includes the following fields: a tail (or produce) pointer (Tail_Ptr) field 80; a count (P_Count) field 82; a threshold field 84; and a ring size field 86. Both the head and tail descriptors can include the same encoded value indicating the ring size, which is used to determine when to “wrap” a pointer to the beginning of the ring array.

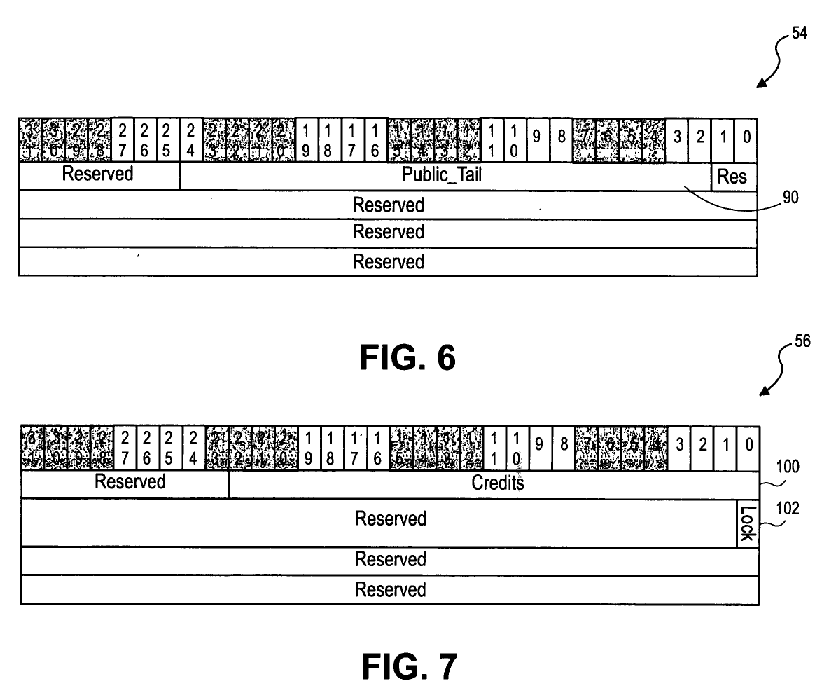

FIG. 6 shows an exemplary data structure layout for the public descriptor 54. The public descriptor 54 is written by the producer and read by the consumer. Accesses to a public descriptor may thus cause cache coherence traffic among the caches in the system 10. The public descriptor 54 includes a public tail pointer (Public_Tail) field 90 to store an approximate version of tail pointer stored in the Tail_Ptr field 80 of the tail descriptor 52. The approximate tail pointer indicates all or fewer of the entries that have been written into the ring array 41 for the referenced ring and may indicate fewer entries than are indicated in the private tail pointer 80 in the tail descriptor 52.

Referring now to FIGS. 4-6, the head descriptor 50 contains data private to the consumer, the tail descriptor 52 contains data private to the producer and the public descriptor 54 contains a public version of the produce pointer communicated to the consumer. The head (consume) pointer stored in the head pointer field 70 provides the address of the next item (entry) to be read from the ring by a consume access operation (e.g., based on a ME generated ‘get’ command). The tail pointer stored in the Tail_Ptr field 80 contains the address of the next item to be written to the ring by a produce access operation (e.g., as generated by a ME ‘put’ command). In a preferred embodiment the head and tail pointers are initialized with the physical address (location in the shared memory) of the base of the ring data storage region 41. The Prev_Tail field 72 stores the most recently cached value of the public tail pointer. The C_Count 74 contains the amount of data (number of entries) on the ring available for a consume access operation. Whenever the value in the C_Count field 74 indicates an amount of data present in the ring that is smaller than was requested by the consumer, the public value of the produce pointer, that is, the public tail pointer stored in the Public_Tail field 90, is obtained from the public descriptor 54 in shared memory, the (wrapped if necessary) delta between that and the cached (previous tail pointer) value is determined, and the resulting value (indicating the number of entries enqueued since the last check) is added to the C_Count field 74. The Prev_Tail field 72 maintains a copy of the public tail pointer most recently read from the Public_Tail field 90 in the Public Descriptor 54

Referring to FIGS. 5-6, the value in the P_Count field 82 indicates the amount of data, in number of entries, that have been added to the tail of the ring since the last update to the Public_Tail field 90. An entry can be of any size mutually agreed upon by the producer(s) and consumer(s) sharing a ring. When the value in the P_Count field 82 becomes greater than the threshold stored in the Threshold field 84, the value of the Tail_Ptr field 80 is copied to the Public_Tail field 90 and the value in the P_Count field 82 is set to ‘0’. Updates to the Public_Tail field can also be triggered by a timeout mechanism, as is described later with reference to FIG. 11. The initial value of P_Count 82 is ‘0’.

A higher threshold causes less frequent updates, and therefore uses fewer cycles on the FSB 16. A higher threshold also causes more delay in notifying consumers of new information on the ring. The threshold field might contain the threshold value or a code indicating a threshold value. In one implementation, 3-bit values can be used to define eight corresponding thresholds (each specifying a given number of entries).

Thus, the value in the P_Count field 82 provides a count of the number of items enqueued since the last time the public produce pointer was updated with the value of the private (actual) produce pointer, and the threshold value stored in the Threshold field 84 is compared to the count to determine when to update the public pointer and thus pass those new items to the consumer. The Public_Tail field 90 is read by the consumer and used to update the C_Count field 74 in the head descriptor 50 whenever the value of the C_Count field 74 is less than the amount of data need to satisfy a consume access operation. The private and public copies of the produce pointer therefore serve to moderate notification to the consumer and to minimize cache/memory traffic. Note that the consumer could periodically poll the ring, or be notified by a sideband communication (such as an interrupt) from the producer that there is data in the ring to be serviced, possibly with a threshold to batch such notification and possibly with an associated timer in order to bound notification delays. To support polling, the ring data structures could be configured to return a NULL value if not enough data is present in the ring to satisfy the size requested.

FIG. 7 shows an exemplary data structure layout for the credit descriptor 56, which is accessed by both the producer and consumer. Accesses to a credit descriptor can thus cause cache coherence traffic on the FSB 16. The credit descriptor 56 holds a Credits field 100 and a Lock field 102. The Credits field 100 is a count to indicate the number of free locations available on the ring. The initial value in the Credits field 100 is the maximum size of the ring (that is, the number of locations, based on the specified ring size.) The Lock field 102 is a bit used to allow exclusive access to the Credits field 100 by producers and consumers. Both producer and consumer lock the Credit Descriptor by setting the Lock bit in the Lock field 102 before modifying the Credits field 100. They can obtain and release the mutual exclusion lock represented by the Lock bit with an atomic swap instruction using well-known algorithms, and can modify the Credits value only when they have acquired the lock.

Ring credit exchange between a consumer and producer might represent the actions of a single ring user at each end of the ring, or might represent the collective actions of a multiplicity of ring users sharing that ring at either end. Each user on a shared ring can use the mutual exclusion lock to atomically draw credits from the public credit count into a local, private variable or to return credits to the public pool. The public credit count value is incremented by the consumer and decremented by the producer as credits are moved from a consuming user's private local “pool” (a private credits count maintained in a local credits variable by a user at the consuming end of the ring) to the public credit pool (that is, the credit descriptor's Credit field value e.g. Credits 100 in credit descriptor 56) to a producing user's private local pool (a private credits count maintained in a local credits variable by a user at the producing end of the ring). In the illustrated embodiment, the ring users themselves maintain the local credit variables and perform the credit management. Alternatively, or in addition, the private credits count(s) could be stored with other local variables in the ring descriptors (the head descriptor for a consumer's private credit count and the tail descriptor for a producer's private credit count).

The producer subtracts the number of ring locations written during produce access operations from the available local credits. The producer replenishes its local credits from the Credits field 100 whenever it determines that the number of local credits has dropped below a low “watermark” (or threshold level). For example, the producer could take 5000 credits from the public credit pool whenever the number of local credits goes below 200, checking first to make sure that public credit pool would not go below zero as a result. Allocating the credits in a group and caching them locally in this manner minimizes the amount of shared memory traffic used to allocate the ring credits. The consumer accumulates credits into its local credits variable each time it finishes processing data it has read from the ring, adding the number of removed ring items to the local credits. When the consumer determines that the number of local credits has gone above a high watermark (or threshold level) the consumer adds the local credits to the Credits field 100. Accumulating credits locally and then returning the credits in a group minimizes the amount of shared memory traffic used to return the ring credits to the public credit pool. There will actually be more space available on the ring than indicated in credits, because of the batching up of allocating and freeing credits described above. A large number of (or all available) credits may be allocated or freed at one time to minimize accesses and the likelihood of collisions to the shared Credits field, which is incremented and decremented under protection of a mutual exclusion lock (mutex) shared between a hardware ring manager 30 and a software ring manager 32 in the shared memory.

In one exemplary embodiment, the credit management is executed in software on the GPP 14 and the ring users of the processor 12. Alternatively, the credit management could be performed by hardware. Note also that this mechanism does not preclude multiple producers writing into a particular ring or multiple consumers from reading from a particular ring. In that situation, it is desirable to set the watermark thresholds such that all producers are able to prefetch sufficient credits into their local credit pool without starving the other producers, and the rings are sized appropriately to account for the less-efficient ring utilization due to multiple such “credit caches”. In addition, when multiple producers are sharing a ring, the producer should not automatically fetch all available credits, rather having a policy which ensures that greedy credit-fetching does not starve the peer producers. The ring size and the consumer thresholds for returning credits must similarly account for the fact that more than one consumer is collecting credits for batch return to the pool for that ring. The watermark threshold values for drawing credits from the public pool and for returning credits to the public pool are all configurable uniquely per ring and per ring user.

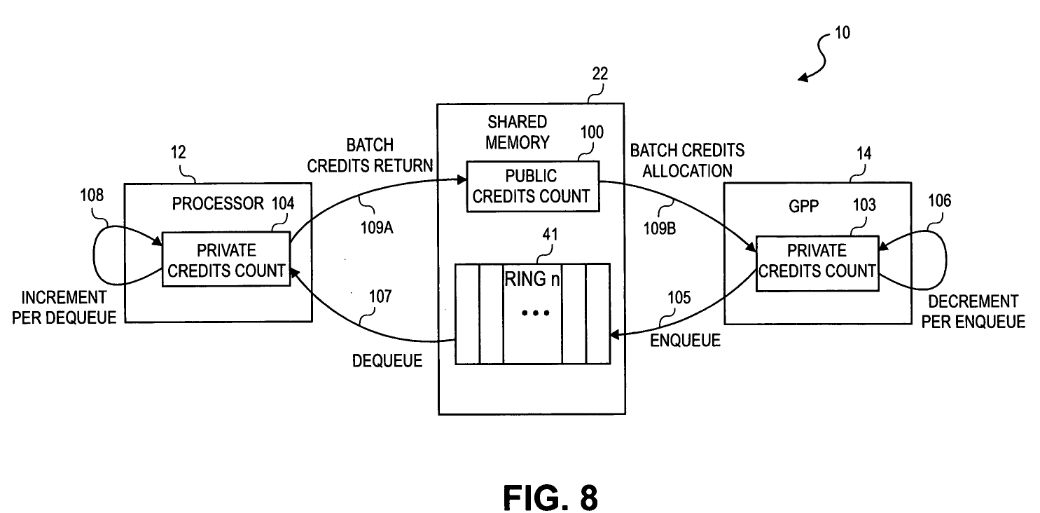

FIG. 8 shows an exemplary use of private and public credit counts in the multi-processing environment of FIG. 1. This example illustrates transfer of credits for a single ring, shown as ring ‘n’ 41, for a given direction configuration in which the GPP 14 is operating as a producer and the processor 12 is operating as a consumer with respect to ring ‘n’. As shown in the figure, a private credits count 103 for ring ‘n’ is maintained in the GPP 14 and a private credits count 104 is maintained for ring ‘n’ in the processor 12 (more specifically, by a particular ring user in processor 12). It will be appreciated that each processor would maintain at least one separate private credits count for each ring in use, and that the direction of use for each ring is based on that ring's configuration, as discussed earlier. Thus, for another ring, the GPP 14 could be consumer and a ring user in the processor 12 could be the producer. In this example, the producer enqueues entries to the ring (as indicated by arrow 105). The producer decrements by one the private credits count 103 for each entry enqueued (as indicated by arrow 106). The consumer dequeues ring entries (as indicated by arrow 107) and increments the private credits count 104 by one for each entry dequeued (as indicated by arrow 108). Periodically, or at the beginning of a dequeue operation (responsive to detection of a high watermark threshold crossing), the consumer causes the transfer of credits, in batches, from the private credits count 104 to the ring's public credits count 100 (as indicated by arrow 109a). Periodically, or at the beginning of an enqueue operation (responsive to detection of a low watermark threshold crossing), the producer causes the transfer of credits, in batches, from the public credits count 100 to the private credits count 103 (as indicated by arrow 109b). The transfer of credits entails subtracting the credits from the public credit count under protection of the mutual exclusion lock, and adding the credits to the private producer credits count.

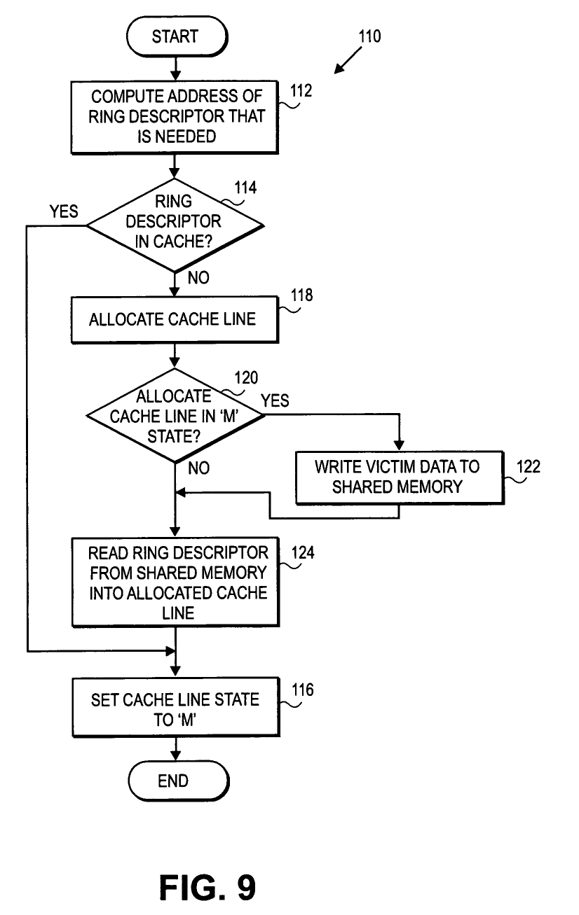

Consume access (dequeue) and produce access (enqueue) operations both access parts of the ring descriptor. Referring to FIG. 9, in one exemplary embodiment, the following tasks for a ring descriptor read 110 are performed for both operations. First, the ring manager computes 112 the address of the ring descriptor that is required by the operation 112. The ring descriptor is determined by adding a multiple of the ring number to the appropriate base value, where the multiplier represents the size of an entry. For example, for the head descriptor, the ring number times ‘n’ is added to the value stored in Ring_Head_Base CSR. Next, the ring manager determines 114 if the indicated ring descriptor is in the cache. For the case of a cache hit, the ring manager sets 116 the cache line state to ‘M’ (i.e., the Modify MOSI state). For the case of a cache miss, the ring manager allocates 118 a cache line. It determines 120 if the allocated cache line is in the ‘M’ state. If the allocated cache line is determined to be in the ‘M’ state, the ring manager initiates 122 a FSB memory write to write out (“flush”) the victim data to the shared memory. The ring manager reads 124 the cache line fill data returned from the shared memory (at the computed address) into the allocated cache line in the cache via an FSB memory read, and sets the cache line state to ‘M’ (at 116).

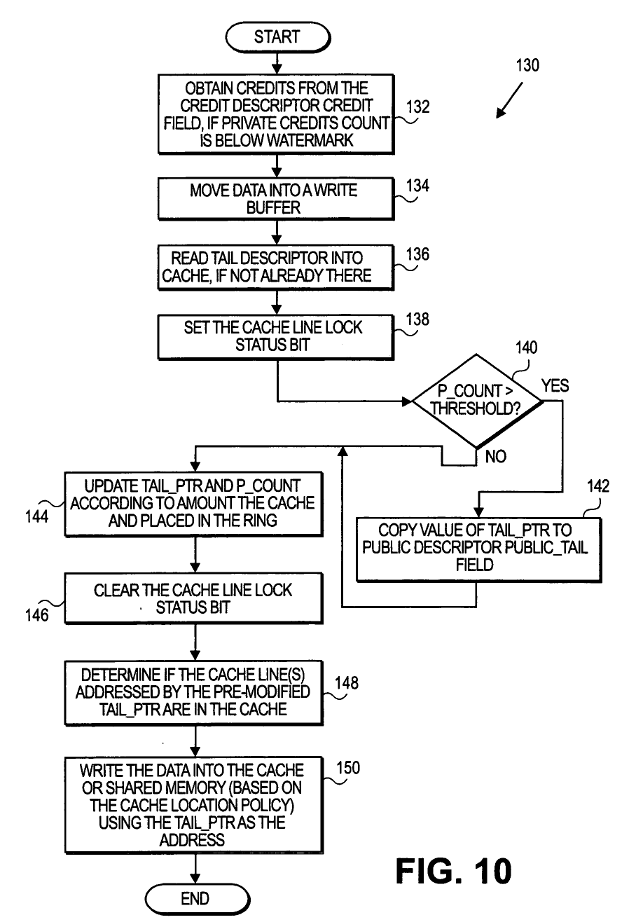

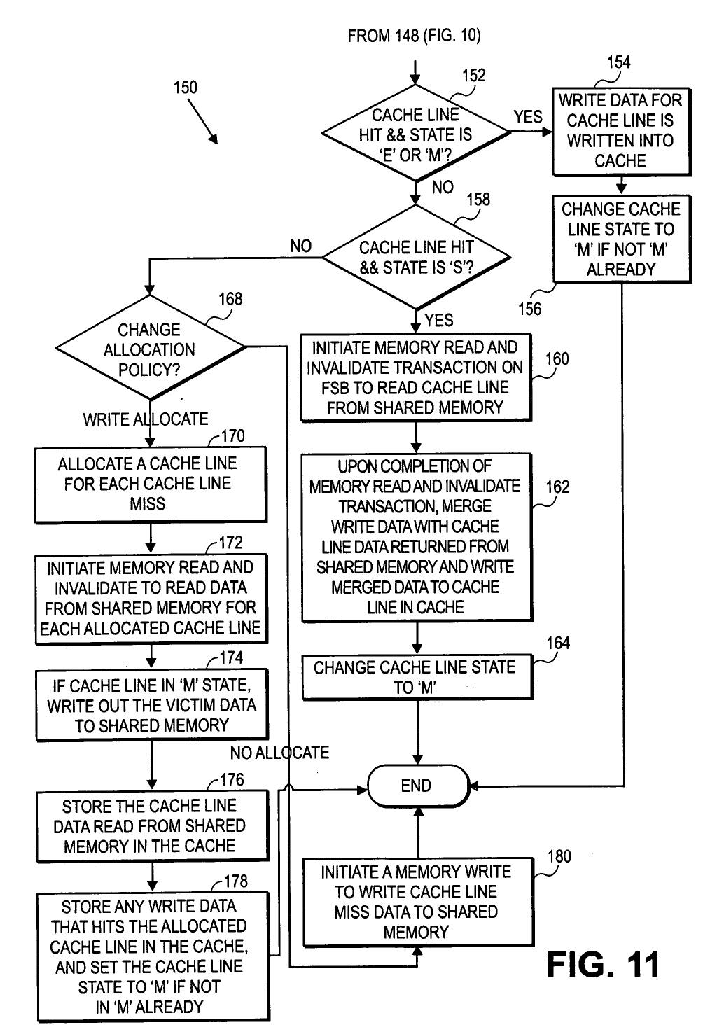

Referring to FIG. 10, an exemplary produce access operation 130 is shown. The agent requesting the operation obtains 132 credits from the credit descriptor field, if the private credits count has dropped below a predetermined low watermark. The requesting agent also moves 134 the data to be added to the ring to a write buffer. The ring manager reads 136 the tail descriptor into cache, if it determines that the tail descriptor does not already reside in cache. This tail descriptor read may be performed according to the ring descriptor read 110, described with reference to FIG. 9. The ring manager sets the lock status bit associated with the cache line holding the tail descriptor to “lock” the cache line, that is, to ensure completion of a sequence of operations on that cache line atomically without any interruption from coherence activity. It compares 140 the value in the P_Count field to the threshold value in the Threshold field to determine if the value in the P_Count field is greater than that of the threshold. If this comparison indicates that the P_Count value is greater than the threshold, the ring manager copies 142 the tail pointer held in the Tail_Ptr field 80 to the public descriptor's Public_Tail field to update the public tail pointer. If the P_Count value is not greater than the threshold, or after the Public_Tail field update is performed, the ring manager updates 144 the values in the Tail_Ptr and P_Count fields according to the amount of data being written to the ring as well as the cache, and clears 146 the cache line lock status bit to “unlock” the cache line.

Still referring to FIG. 10, the ring manager checks 148 the cache to determine if the cache has a copy of the cache line(s) addressed by the pre-modified tail pointer. The ring manager writes 150 the data into the cache or shared memory, based on the cache allocation policy, using the value of the Tail_Ptr as the address. It will be noted that, while the ring descriptors are always cached, the ring write (as well as read) data is only cached if the cache allocation policy configured for that address indicates a cache allocation should occur.

The shared memory write 150 is much the same as the shared memory write used for non-ring-related shared memory accesses, except that the address used in the ring case is derived indirectly from the ring number and command. Details of the memory write 150, according to one exemplary implementation, are as shown in FIG. 11. Referring to FIG. 11, the ring manager determines 152, for each cache line, if the write data hits the cache line and the cache line has a state that is ‘E’ or ‘M’. If so, no FSB transaction is needed. The ring manager writes 154 data that hits that cache line into the cache, and changes 156 the cache line state from ‘E’ to ‘M’ (or leaves the state unchanged if in the ‘M’ state already.) If the ring manager determines 158 that data hits the cache line and the cache line state is ‘S’, then the ring manager initiates 160 a FSB Memory Read and Invalidate on the FSB. When that transaction has completed, the ring manager causes 162 the write data to be merged into the cache line returned from shared memory and the merged data to be written into the cache. The ring manager changes 164 the cache line state to ‘M’. If any part of the addressed data is not in the cache, the next operation depends on the cache allocation policy, and so the ring manager checks 168 the cache allocation policy. If the cache allocation policy is ‘write allocate’, the ring manager allocates 170 a cache line for each cache line that was missed, and initiates 172 a FSB read to fill that cache line. The FSB read uses a request type of Memory Read and Invalidate and attribute of WB. The ring manager initiates 174 a FSB Memory Write to write out the victim data to the shared memory for any allocated cache line in an ‘M’ state. As the data for each cache line fill is returned on the FSB 16, the ring manager stores 176 that data in the allocated line in the cache. The ring manager writes into the cache the write data that hit the allocated cache line, and sets 178 the cache line state to ‘M’ (if not set to ‘M’ already). If, at 168, it is determined that the cache allocation policy is ‘no allocate’, the ring manager initiates 180 a FSB write for each block of addresses that is not found in the cache. The FSB write uses request type of Memory Write and attribute of WC.

All activities but the credits update (at 132) are performed by the ring manager 30 in the processor 12. Similar activities are performed by the software ring manager 32 running on the GPP 14.

Produce access operations update the value of Public_Tail based on the threshold value, as described above (at 140 and 142). To handle the case where accumulated operations do not reach the threshold for a long time (for example, due to a pause in the production of messages) a timeout mechanism may be provided to ensure that consumers are notified of the arrival of those messages. Otherwise, the P_Count value for a particular ring and ring descriptor may stay the same for an unbounded amount of time. The timeout may be handled by the ring manager hardware for rings used for processor ring users 31 to GPP 14 communications, and by the ring manager software in the GPP 14 for rings used by the GPP 14 as a producer and ring users 31 as consumers for communications going in the opposite direction.

One example of a timeout mechanism would be a hardware process in the ring manager 30 and a software process in the routines of the ring manager 32 that scans all of the tail/produce descriptors and triggers an update for a particular ring if that ring was non-empty when visited. Each ring would be visited once per timeout period.

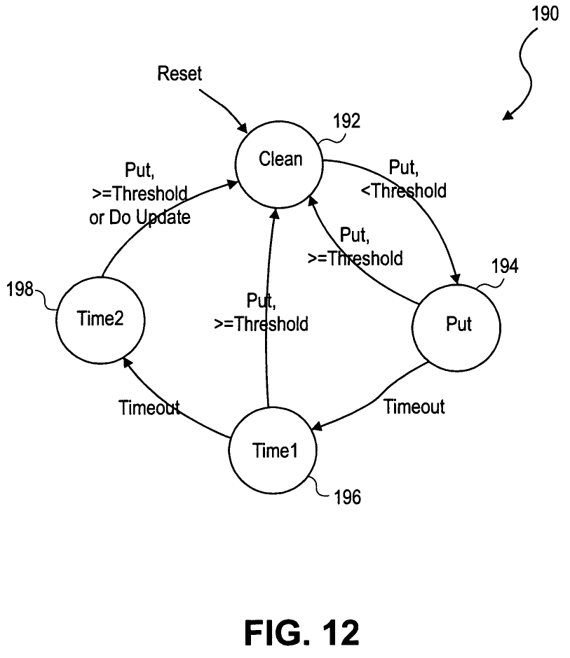

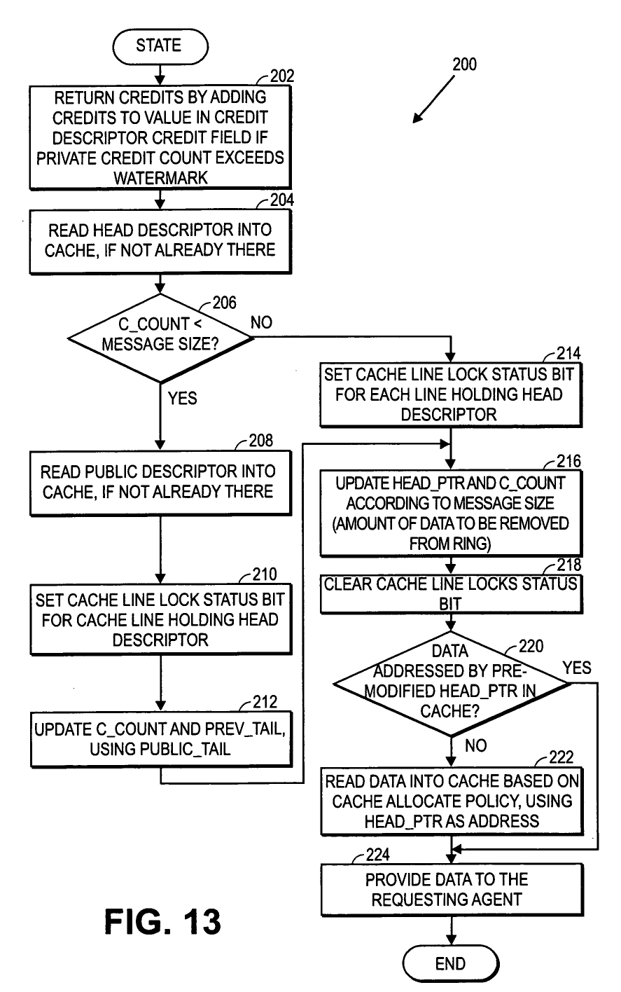

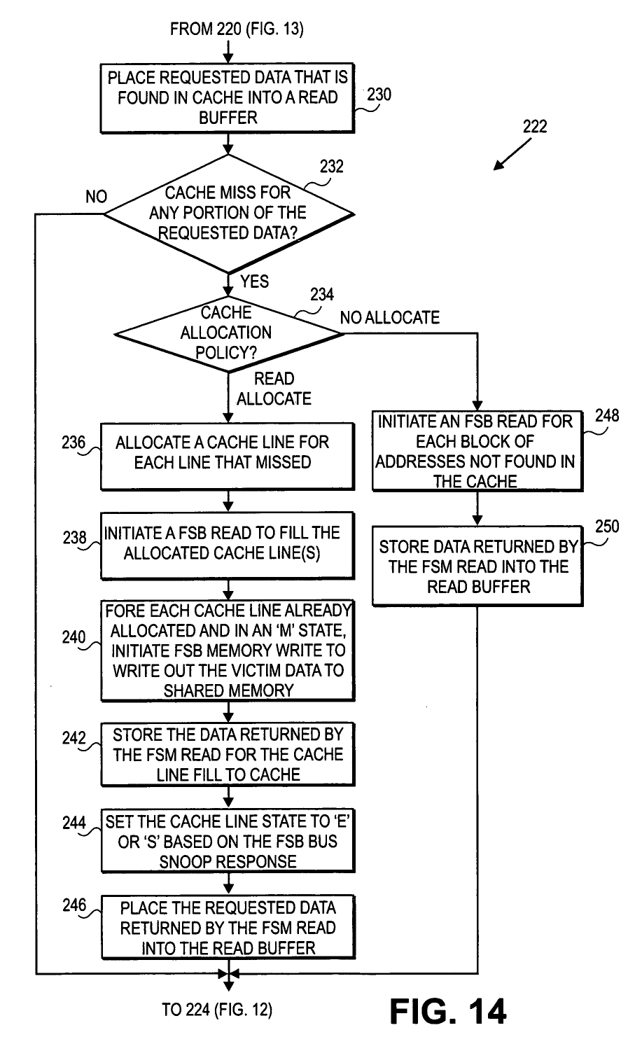

In another example implementation, the ring manager 30 may include timeout support in the form of timeout state machines to manage timeouts for some number of rings. In such an example, and as shown in FIG. 12, a timeout state machine (SM) 190 operates as follow. At reset, the timeout SM is put in a “Clean” state (state 192). When a Put command is executed, the state for that ring is set to a “Put” state (state 194). On timeout, the state machine advances from “Put” state to a “Time1” state (state 196). On a second timeout, the timeout SM advances from the “Time1” state to a “Time2” state (state 198). In the “Time2” state, an update (write) of the tail descriptor's Tail_Ptr 80 (from FIG. 5) to the public descriptor's Public_Tail 90 is pending. There are two exits from the “Time2” to the “Clean” state. At the next dispatch of the main FSB state machine, if the Timeout SM is in “Time2” state, it performs the update. Alternatively, if the timeout SM entered the “Time2” state and an update done during a Put is in progress, the timeout SM goes immediately to the “Clean” state, because that event will do the update to Public_Tail. The timeout SM 160 records any outstanding Put operations not yet updated to Public_Tail. Instead of triggering an update immediately, the timeout SM 190 waits for two timer intervals. At that time, if the put operation is still outstanding, the update is done. With the extra waiting, it is likely that a ring with frequent use will cross the threshold (and therefore require a “normal” update) before the timer triggers an update.

It may be desirable to reduce the frequency of updates to the public produce pointer when the produce pointer is maintained in a shared coherent memory and the agents have different cached copies, as described above. Each write access to the produce pointer puts that copy in the ‘M’ state in the writer's cache, and subsequent writes can be immediately serviced. Each read of that pointer by the other agent moves it to ‘S’ state in both caches, requiring the writer to go out on the coherent bus to regain exclusive ownership of the pointer variable for the next enqueue-increment. It is advantageous to minimize the number of such coherent transactions as messages are passed with high throughput between agents. Batching of notification can also help to optimize software in high-throughput situations by amortizing the software overheads of entering and leaving the service routine, only invoking it when there are a whole batch of entries to service (or expecting a high success rate when polling the ring periodically.) The timeout mechanism to force the update of the public pointer helps to ensure that a partial batch does not wait too long for service.

FIG. 13 shows an exemplary consume access operation 200. The requesting agent returns 202 credits, if necessary, by adding credits to the value of the credit descriptor credit field if a private credit count, maintained locally by the agent, exceeds the predetermined high watermark. The ring manager reads 204 the head descriptor into the cache, if it is not already in cache. The head descriptor read is performed according to the ring descriptor read 110 (FIG. 9).

The ring manager compares 206 the value in the C_Count field 74 in the head descriptor to the message size to determine if enough data is available on the ring to complete the requested operation. If the C_Count 74 test indicates that there is not enough data on the ring (that is, the value in the C_Count field 74 is less than the message size), then the ring manager reads 208 the public descriptor 54 into cache, if the public descriptor 54 is not cached already. The public descriptor read can also be performed according to the ring descriptor read 110 (FIG. 9). The ring manager sets 210 the cache line lock status bit for the cache line holding the head descriptor. It updates 212 the values of the C_Count 74 and the Prev_Tail 72 fields using the value of the Public_Tail 90 field, as described earlier. If, at 186, the value of the C_Count field 74 indicates that there is enough data on the ring to complete the requested operation, then no updates to C_Count 74 and Prev_Tail 72 are performed. Instead, the C_Count 74 test is followed by setting 214 the cache line lock status bit for the cache line holding the head descriptor.

After the cache line lock status bit is set and any necessary head descriptor updates of the C_Count 74 and Prev_Tail 72 fields based on the Public_Tail 90 field are performed, the ring manager updates 216 the Head_Ptr 70 and C_Count 74 fields according to the message size (amount of data being removed from the ring). Once it has made those updates, the ring manager clears 218 the cache line lock status bit.

The ring manager checks 220 the cache to determine if it holds all of the data addressed by the pre-modified head pointer. If there is a cache miss, the ring manager reads 222 that data from the shared memory into the cache, based on the cache allocation policy using the head pointer as the address. The ring manager then provides 224 the data to the requesting agent. If the data already resides in the cache, then it is provided to the requesting agent (at 224) without the need for the FSB shared memory access.

The shared memory read is much the same as that used for non-ring-related shared memory accesses, except that the address used in the ring case is derived from the ring number. Details of the shared memory read access 222, according to one exemplary implementation, are as shown in FIG. 14. Referring to FIG. 14, the ring manager transfers 230 to a read buffer any of the requested data that is found in the cache. The data is held there until all requested read data is in the read buffer. The ring manager determines 232 if any part of the addressed data is not in the cache. If so, the ring manager checks 234 the cache allocation policy. If the cache allocation policy is ‘read allocate’, the ring manager allocates 236 a cache line for each cache line miss and initiates 238 a FSB read to fill that allocated cache line. Each FSB read uses a request type of Memory Data Read and attribute of WB. For each line that was previously allocated, if the line was in ‘M’ state, the ring manager initiates 240 a FSB Memory Write to write out the victim data to the shared memory. As the data for each cache line fill comes back on the FSB 16 it is stored 242 in the allocated line in the cache, and the cache line state is set 244 to ‘E’ or ‘S’, depending on the FSB bus snoop response (‘E’ if not found in another cache, ‘S’ if it was found in another cache). Also, the ring manager stores 246 in the read buffer the data words that were requested by the read instruction. Once all the requested read data is in the read buffer, the ring manager provides it to the requesting ring user (at 224, FIG. 13). If, at 234, the ring manager determines that the cache allocation policy is ‘no allocate’, it initiates 248 an FSB read for each block of addresses that is not found in the cache. Each FSB read uses a request type of Memory Data Read and attribute of WB. As the data for each read comes back on the FSB 16 it is stored 250 in the read buffer, but not into the cache. Once all the requested read data is in the read buffer, it is provided to the requesting ring user (at 224, FIG. 13).

All activities but the credits update (at 202) are performed by the ring manager 30 in the processor 12. Similar activities are performed by the ring manager software running on the GPP 14.

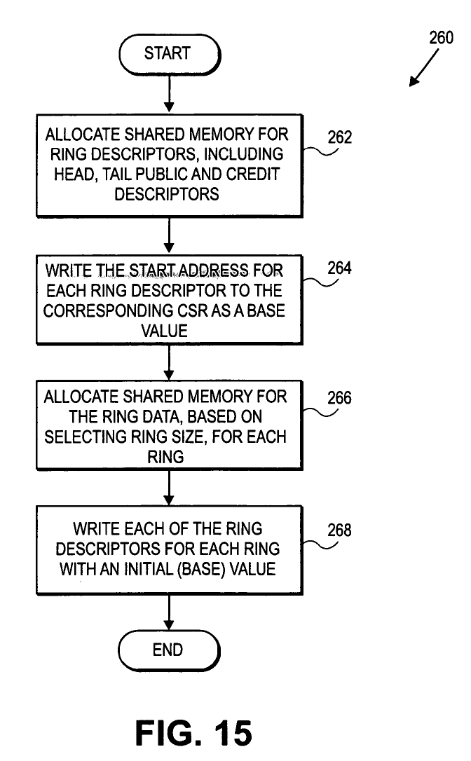

Before a given ring can be used it must be initialized. Initialization is handled by software executing on the agents, e.g., the processor's ring users 31, or the GPP 14. Referring to FIG. 15, an exemplary initialization process 260 begins by allocating 262 shared memory to the ring descriptors. Four regions are allocated, one for the array of head descriptors, one for the array of tail descriptors, one for the array of public descriptors, and one for the array of credit descriptors, as discussed earlier. The process 260 writes 264 the start address for each of the four regions into the Ring_Head_Base, Ring_Tail_Base, Ring_Public_Base, and Ring_Credit_Base CSRS, respectively. The process 260 allocates 266 storage in the shared memory for the ring data storage region, based on selected ring size, for each ring. The process initializes 268 each of the four ring descriptors for each ring by writing those descriptors with a base value for the ring data storage region. The produce pointer and the consume pointer for a particular ring are initialized to the same value. The Head and Tail structures replicate the size information and the ring base (the part of the pointer that is not incremented) to avoid the need for coherence traffic around unnecessarily shared information.

As indicated above, multiple producers and/or consumers may operate on ring data from the same processor. For example, multiple processor cores may wish to write/read data to/from a ring. A variety of implementations can handle multiple producers/consumers. For example, a processor may feature a single ring producer and/or consumer agent that handles ring requests received from other agents. For example, the different processor cores may funnel ring access requests into a queue serviced by a ring producer thread operating on one of the cores. In such an implementation the single processor ring producer and/or consumer agent may have exclusive control of the data in private producer and/or consumer data structures.

Alternately, the different producers and consumers may independently access the ring data structures of a given ring. In such an implementation, mechanisms (e.g., a mutual-exclusion lock (“mutex”)) may be used to resolve contention issues between the agents. For example, the head and tail descriptors may be protected by mutual-exclusion (mutex) locks that restrict access to the descriptors to one respective consumer or producer agent at a time. Alternately, mutexes may be used at finer granularity. For instance, one mutex may lock the private consumer pointer while another locks the private consumer credit count. Additionally, the multiple agents may maintain their own credit pools that they contribute to/take from the private producer/consumer credit pools.

To illustrate operation of an implementation featuring multiple independent producers, the producers can write ring entries by, for example, acquiring a mutex to the private producer pointer; obtaining the necessary credits from the producer credit count; writing the ring entries; updating the private producer pointer; and releasing the mutex. Potentially, the producer may adjust the shared producer pointer and/or the shared credit count which may also entail acquiring respective mutexes. Likewise, multiple independent consumers can dequeue ring entries by, for example, acquiring a mutex to the private consumer pointer; dequeuing ring entries; updating the private consumer pointer; and releasing the mutex. Potentially, a given consumer may update the private consumer credit pool and/or the public credit pool. Again, this updating may require acquisition of one or more mutexes.

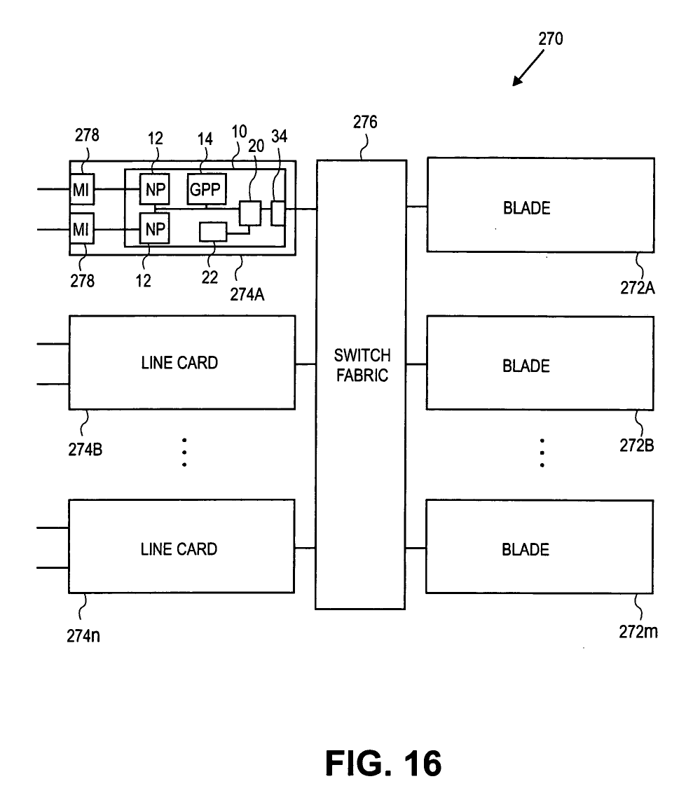

The multi-processor system 10 (of FIG. 1), with ring management and cache/memory coherency, as described above, may be used in a variety of applications. In networking applications, for example, it is possible to closely couple packet processing and general purpose processing for optimal, high-throughput communication between packet processing elements of a network processor and the control and/or content processing of general purpose processors. For example, as shown in FIG. 16, a distributed processing platform 270 includes a collection of blades 272a-272m and line cards 274a-274n interconnected by a backplane 276, e.g., a switch fabric (as shown). The switch fabric, for example, may conform to Common Switch Interface (CSIX) or other fabric technologies such as Advanced Switching Interconnect (ASI), HyperTransport, Infiniband, Peripheral Component Interconnect (PCI), Ethernet, Packet-Over-SONET, RapidIO, and/or Universal Test and Operations PHY Interface for ATM (UTOPIA).

The line card is where line termination and I/O processing occurs. It may include processing in the data plane (packet processing) as well as control plane processing to handle the management of policies for execution in the data plane. The blades 272a-272m may include: control blades to handle control plane functions not distributed to line cards; control blades to perform system management functions such as driver enumeration, route table management, global table management, network address translation and messaging to a control blade; applications and service blades; and content processing blades. The switch fabric or fabrics may also reside on one or more blades. In a network infrastructure, content processing may be used to handle intensive content-based processing outside the capabilities of the standard line card functionality including voice processing, encryption offload and intrusion-detection where performance demands are high.

At least one of the line cards, e.g., line card 274a, is a specialized line card that is implemented based on the architecture of system 10, to tightly couple the processing intelligence of a general purpose processor to the more specialized capabilities of a network processor. The line card 274a includes media interfaces 278 to handle communications over network connections. Each media interface 278 is connected to a processor 12, shown here as network processor (NP) 12. In this implementation, one NP is used as an ingress processor and the other NP is used as an egress processor, although a single NP could also be used. Other components and interconnections in system 10 are as shown in FIG. 1. Here the system logic and I/O block 34 in the system 10 is coupled to the switch fabric 276. Alternatively, or in addition, other applications based on the multi-processor system 10 could be employed by the distributed processing platform 270. For example, for optimized storage processing, desirable in such applications as enterprise server, networked storage, offload and storage subsystems applications, the processor 12 could be implemented as an I/O processor. For still other applications, the processor 12 could be a co-processor (used as an accelerator, as an example) or a stand-alone control plane processor. Depending on the configuration of blades and line cards, the distributed processing platform 270 could implement a switching device (e.g., switch or router), a server, a voice gateway or other type of equipment.

The techniques described above may be implemented in a variety of logic. The term logic as used herein includes hardwired circuitry, digital circuitry, analog circuitry, programmable circuitry, and so forth. The programmable circuitry may operate on instructions disposed on an article of manufacture (e.g., a volatile or non-volatile memory device).

Other embodiments are within the scope of the following claims.

What is claimed is:

1. A system comprising:
memory;
a first processor, comprising:
at least one associated cache; and
logic to operate as a consumer of at least one of a set of at least one ring of entries stored in the memory, the logic to:
dequeue entries from the at least one ring;
adjust a consumer credit count for the at least one ring of entries based on a number of ring entries dequeued;
adjust a shared credit count for the at least one ring of entries based on the consumer credit count for the at least one ring of entries;
set a consumer producer pointer for the at least one ring of entries based on a shared producer pointer for the at least one ring of entries;
a second processor having:
at least one associated cache;
logic to operate as a producer of the at least one of the set of at least one ring of entries stored in the memory, the logic to:
enqueue entries to the at least one ring;
adjust a producer credit count for the at least one ring of entries based on a number of ring entries enqueued;
adjust the producer credit count for the at least one ring of entries based on the shared credit count for the at least one ring of entries;
adjust the shared credit count for the at least one ring of entries based on the adjustment to the producer credit count for the at least one ring of entries;
adjust a producer producer pointer for the at least one ring of entries based on ring entries enqueued;
set the shared producer pointer for the at least one ring of entries to the producer producer pointer for the at least one ring of entries; and
a bus interconnecting the memory, the first processor, and the second processor.

2. The system of claim 1, wherein at least one of the first processor and the second processor comprises a processor having multiple processor cores integrated within a single die.

3. The system of claim 1,
wherein one of the consumer logic and the producer logic consists of hardware; and
wherein one of the consumer logic and the producer logic comprises software instructions.

4. The system of claim 1,
wherein the logic to operate as a consumer to adjust the shared credit count comprises logic to add at least some of the consumer credit count to the shared credit count based on a comparison of the consumer credit count to a threshold.

5. The system of claim 1,
wherein the logic to operate as a producer to adjust the producer credit count comprises logic to add at least some of the shared credit count to the producer credit count based on a comparison of the producer credit count to a threshold.

6. The system of claim 5, wherein the logic to operate as a producer to add at least some of the shared credit count comprises logic to add less than the total of the shared credit count.

7. The system of claim 1, wherein the logic to operate as a producer comprises logic to operate as multiple producers.

8. The system of claim 7, wherein the multiple producers acquire at least one mutual-exclusion lock for at least one selected from the following group of: accessing the shared credit count; accessing the shared producer pointer; and enqueuing at least one entry to the at least one ring of entries stored in memory.

9. The system of claim 1, wherein the logic to operate as a producer comprises logic to service producer requests from multiple agents.

10. The system of claim 1, wherein the logic to operate as a consumer comprises logic to operate as multiple consumers.

11. The system of claim 10, wherein the multiple consumers acquire at least one mutual-exclusion lock for at least one selected from the group of: accessing the shared credit count; accessing the consumer consumer pointer; and dequeuing at least one entry from the at least one ring of entries stored in memory.

12. The system of claim 1, wherein the logic to operate as a consumer comprises logic to service consumer requests from multiple agents.

13. The system of claim 1, wherein the consumer credit count, shared credit count, producer credit count, shared producer pointer, consumer producer pointer, and producer producer pointer comprise variables stored in different data structures stored in the memory.

14. The system of claim 13, wherein at least one of the data structures stored within the memory is cacheable in at least one of the caches of the first and second processor.

15. The system of claim 1, wherein at least one of the set of at least one ring of entries stored in the memory is cacheable within at least one cache of at least one of the first processor and the second processor.

16. The system of claim 1, wherein the set of at least one ring comprises multiple rings.

17. The system of claim 16, wherein the logic of the first processor comprises logic to operate as a producer of a second ring and the logic of the second processor comprises logic to operate as a consumer of the second ring.

18. The system of claim 17, further comprising configuration data identifying which of the first processor and the second processor operate as the producer and which of the first processor and the second processor act as the consumer for a given one of the set of multiple rings.

19. The system of claim 1,
wherein the first processor and second processor comprise processors within a set of more than two processors, processors in the set of processors other than the first and second processors comprising logic to operate as at least one selected from the following group: (1) operate as a producer of at least one of the set of at least one ring of entries in memory; and (2) operate as a consumer of at least one of the set of at least one ring of entries in memory.

20. The system of a claim 1, wherein the cache of the first processor and the cache of the second processor implement a cache coherence protocol.

21. The system of claim 1, wherein the adjusting the consumer producer pointer based on the value of the shared producer pointer comprises adjusting in response to at least one selected from the following group: (1) periodic polling; and (2) an event indicating at least one ring entry to dequeue on at least one of the set of at least one ring of entries.

22. A method, comprising:
a consumer:
dequeuing entries from a ring;
adjusting a consumer credit count based on a number of ring entries dequeued;
adjusting a shared credit count based on the consumer credit count;
set a consumer producer pointer based on a shared producer pointer; and
a producer:
enqueuing entries to the ring;
adjusting a producer credit count based on a number of ring entries enqueued;
adjusting the producer credit count based on the shared credit count;
adjusting the shared credit count based on the adjustment to the producer credit count;
adjusting a producer producer pointer based on ring entries enqueued; and
setting the shared producer pointer to the producer producer pointer.

23. The method of claim 22, wherein the adjusting the shared credit count comprises adding the consumer credit count to the shared credit count based on a comparison of the consumer credit count to a threshold.

24. The method of claim 22,
wherein the setting the consumer producer pointer based on the shared producer pointer comprises setting the consumer producer pointer based on an at least one selected from the following group: (1) periodic polling; and (2) an event indicating at least one ring entry to dequeue.

25. The method of claim 22,
wherein the adjusting the producer credit count comprises adding at least some of the shared credit count to the producer credit count based on a comparison of the producer credit count to a threshold.

26. The method of claim 25, wherein the adding at least some of the shared credit count comprises adding less than the total of the shared credit count.

27. The method of claim 22, wherein the consumer credit count, shared credit count, producer credit count, shared producer pointer, consumer producer pointer, and producer producer pointer comprise variables stored in different data structures stored in the memory.

28. The method of claim 22, wherein the ring comprises one of a set of multiple rings, each ring having an associated shared credit count and shared producer pointer.

29. An article of manufacture comprising instructions, that when executed, provide logic comprising:
a consumer:
dequeuing entries from a first ring;
adjusting a consumer credit count based on a number of entries dequeued from the first ring;
adjusting a shared credit count of the first ring based on the consumer credit count of the first ring;
set a consumer producer pointer of the first ring based on a shared producer pointer of the first ring; and
a producer:
enqueuing entries to a second ring;
adjusting a producer credit count of the second ring based on the entries enqueued to the second ring;
adjusting the producer credit count of the second ring based on the shared credit count of the second ring;
adjusting a producer producer pointer of the second ring based on entries enqueued into the second ring;
adjusting a shared credit count of the second ring based on the adjusting to the producer credit count of the second ring; and
setting the shared producer pointer of the second ring to the producer producer pointer of the second ring.

30. The article of claim 29, wherein the consumer logic to adjust the shared credit count of the first ring comprises consumer logic to add the consumer credit count of the first ring to the shared credit count of the first ring based on a comparison of the consumer credit count of the first ring to a threshold.
